(19) United States
(12) Patent Application Publication
(10) Pub. No.: US 2026/0271997 A1
(43) Pub. Date: Sep. 17, 2026

(54) ARTICLE FOR AN AEROSOL PROVISION DEVICE

(71) Applicant: Nicoventures Trading Limited, London (GB)

(72) Inventors: Tom WOODMAN, London (GB); Mark POTTER, London (GB); Richard HEPWORTH, London (GB); Steven SCHENNUM, Naperville, IL (US)

(21) Appl. No.: 19/469,029

(22) PCT Filed: Mar. 28, 2024
(86) PCT No.: PCT/EP2024/058496

§ 371 Date: Sep. 25, 2025

Related U.S. Application Data
(60) Provisional application No. 63/582,129, filed on Sep. 12, 2023.

(30) Foreign Application Priority Data
Mar. 29, 2023 (GB) 2304638.6
Mar. 29, 2023 (GB) 2304648.5
Sep. 12, 2023 (GB) 2313886.0
Sep. 12, 2023 (GB) 2313892.8
Sep. 12, 2023 (GB) 2313900.9
Nov. 20, 2023 (GB) 2317742.1
Feb. 6, 2024 (EP) 24156142.2

(51) Int. Cl. A24D 1/20; A24C 5/01; H05B 3/26

(52) U.S. Cl. CPC A24D 1/20; A24C 5/01; H05B 3/26

(57) ABSTRACT

An article for an aerosol provision device is provided. The article has an aerosol generating segment comprising aerosol generating material; a resistive heating configuration including a resistive heating layer comprising a resistive heating element configured to heat at least a portion of the aerosol generating material to generate an aerosol; a first type of electrical contact; and a second type of electrical contact. The resistive heating element is at least a portion of an electrically conductive path between the first type of electrical contact and the second type of electrical contact. The resistive heating configuration is in an external contact with the aerosol generating segment and in an internal contact with the aerosol generating segment.

### CROSS-REFERENCE TO RELATED APPLICATIONS

This present application is a National Phase entry of PCT Application No. PCT/EP2024/058496, filed Mar. 28, 2024, which claims priority from Great Britain Application No. 2304638.6, filed Mar. 29, 2023, and which claims priority from Great Britain Application No. 2304648.5, filed Mar. 29, 2023, and which claims priority from Great Britain Application No. 2313886.0, filed Sep. 12, 2023, and which claims priority from Great Britain Application No. 2313892.8, filed Sep. 12, 2023, and which claims priority from Great Britain Application No. 2313900.9, filed Sep. 12, 2023, and which claims priority from U.S. Provisional Application No. 63/582,129 , filed Sep. 12, 2023, and which claims priority from Great Britain Application No. 2317742.1, filed Nov. 20, 2023, and which claims priority from European Application No. 24156142.2, filed Feb. 6, 2024, each of which are fully incorporated herein by reference in their entireties.

### TECHNICAL FIELD

The present invention relates to an article for an aerosol provision device. The present invention also relates to an aerosol provision system, a method of forming an aerosol generator of an article for an aerosol provision device, an aerosol provision device, and a blank for forming an aerosol generator of an article for an aerosol provision device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium.

### SUMMARY

According to an aspect, there is provided an article for an aerosol provision device comprising: an aerosol generating segment comprising aerosol generating material; a resistive heating configuration including a resistive heating layer comprising a resistive heating element configured to heat at least a portion of the aerosol generating material to generate an aerosol; a first type of electrical contact; and a second type of electrical contact; wherein the resistive heating element is at least a portion of an electrically conductive path between the first type of electrical contact and the second type of electrical contact; and wherein the resistive heating configuration is in an external contact with the aerosol generating segment and in an internal contact with the aerosol generating segment.

In an embodiment of any of the above, the article comprises a support layer configured to support the resistive heating layer. In an embodiment of any of the above, the article comprises an aerosol generator comprising the resistive heating layer, the support layer; the first type of electrical contact; and the second type of electrical contact. In an embodiment of any of the above, at least a portion of the resistive heating configuration is embedded in the aerosol generating segment.

In an embodiment of any of the above, at least a portion of the resistive heating arrangement at least partially circumscribes the aerosol generating segment. In an embodiment of any of the above, the resistive heating layer is in external contact with the aerosol generating segment and in internal contact with the aerosol generating segment.

In an embodiment of any of the above, an external portion of the resistive heating element is in external contact with the aerosol generating segment and an internal portion of the resistive heating element is in internal contact with the aerosol generating segment. In an embodiment of any of the above, the resistive heating configuration comprises an internal portion of the resistive heating configuration forming the internal contact with the aerosol generating segment and an external portion of the resistive heating configuration forming the external contact with the aerosol generating segment.

In an embodiment of any of the above, the internal portion of the resistive heating configuration extends in the aerosol generating segment and the external portion of the resistive heating configuration at least partially circumscribes the aerosol generating segment. In an embodiment of any of the above, the internal portion of the resistive heating configuration extends transversely from the external portion.

In an embodiment of any of the above, the article comprises a fold defining the internal portion and the external portion of the resistive heating configuration. In an embodiment of any of the above, the fold provides a first resistive heating panel and a second resistive heating panel. In an embodiment of any of the above, the first resistive heating panel faces in a first direction toward the aerosol generating material and the second resistive heating panel faces in a second, different, direction toward the aerosol generating material.

In an embodiment of any of the above, the internal portion of the resistive heating configuration extends in a radially inward direction from the external portion.

In an embodiment of any of the above, the internal portion of the resistive heating configuration extends in a radially inward direction from the fold. In an embodiment of any of the above, the internal portion of the resistive heating configuration extends in a circumferential direction from the fold.

In an embodiment of any of the above, the internal portion of the resistive heating configuration extends perpendicularly from the external portion. In an embodiment of any of the above, the fold is a first fold and comprising a second fold, wherein the second fold defines a section of the internal portion of the resistive heating configuration. In an embodiment of any of the above, the second fold is disposed in the aerosol generating segment.

In an embodiment of any of the above, the resistive heating configuration is folded in an opposing direction about the second fold than about the first fold. In an embodiment of any of the above, the second fold provides a third resistive heating panel.

In an embodiment of any of the above, the second fold is between the second resistive heating panel and the third resistive heating panel. In an embodiment of any of the above, the third resistive heating panel faces in a different direction toward the aerosol generating material than the second resistive heating panel.

In an embodiment of any of the above, the second fold extends parallel to the longitudinal axis. In an embodiment of any of the above, the second fold extends parallel to the first fold. In an embodiment of the above, the resistive heating element extends across the second fold. In an embodiment of the above, the resistive heating element comprises a third resistive heating element portion. In an embodiment of the above, the third resistive heating element portion and the second resistive heating element portion are formed in series. In an embodiment of the above, the second fold defines a third support layer panel of the support layer.

In an embodiment of the above, the third resistive heating element portion is on the third support layer panel of the support layer. In an embodiment of the above, the second support layer panel and the third support layer panel of the support layer extend in parallel. In an embodiment of the above, the second support layer panel and the third support layer panel of the support layer are mounted together.

In an embodiment of the above, an internal support portion of the support layer extends in the aerosol generating segment. In an embodiment of the above, an external support portion of the support layer extends around the aerosol generating segment. In an embodiment of the above, the internal portion of the resistive heating layer is in direct contact with the aerosol generating segment. In an embodiment of the above, the external portion of the resistive heating layer is in direct contact with the aerosol generating segment. In an embodiment of the above, the support layer is spaced from the aerosol generating material by the resistive heating layer.

In an embodiment of the above, the first type of electrical contact and the second type of electrical contact are configured to engage with a device electrical connector of the aerosol provision device. In an embodiment of any of the above, at least one of the first type of electrical contact and the second type of electrical contact protrude from an end of the aerosol generating segment. In an embodiment of any of the above, each of the first type of electrical contact and the second type of electrical contact protrude from an end of the aerosol generating segment.

In an embodiment of any of the above, the article comprises a mouth end and an opposing upstream end, wherein the first type of electrical contact and the second type of electrical contact are at the upstream end of the article.

In an embodiment of any of the above, at least one of the first type of electrical contact and the second type of electrical contact protrude at the upstream end of the article. In an embodiment of any of the above, at least one of the first type of electrical contact and the second type of electrical contact extends from the internal portion of the resistive heating configuration. In an embodiment of any of the above, each of the first type of electrical contact and the second type of electrical contact extends from the internal portion of the resistive heating configuration.

In an embodiment of any of the above, at least one of the first type of electrical contact and the second type of electrical contact extends from the external portion of the resistive heating configuration. In an embodiment of any of the above, each of the first type of electrical contact and the second type of electrical contact extends from the external portion of the resistive heating configuration.

In an embodiment of any of the above, one of the first type of electrical contact and the second type of electrical contact extends from the internal portion of the resistive heating configuration and the other of the first type of electrical contact and the second type of electrical contact extends from the external portion of the resistive heating configuration.

In an embodiment of any of the above, aerosol generating material is sandwiched between the first resistive heating panel and the second resistive heating panel. In an embodiment of any of the above, the first resistive heating panel and the second resistive heating panel at least substantially enclose aerosol generating material. In an embodiment of any of the above, a portion of the aerosol generating segment extends between the first resistive heating panel and the second resistive heating panel.

In an embodiment of any of the above, the article defines a longitudinal axis and the resistive heating layer extends in the direction of the longitudinal axis.

In an embodiment of any of the above, the article comprises a wrapper around the aerosol generating segment. In an embodiment of any of the above, the wrapper extends around the length of the article. In an embodiment of any of the above, the wrapper circumscribes the aerosol generating segment. In an embodiment of any of the above, the wrapper is a paper or card wrapper.

In an embodiment of any of the above, the internal portion of resistive heating layer extends diametrically.

In an embodiment of any of the above, the resistive heating element is a first resistive heating element defined by the internal portion of the resistive heating configuration and the resistive heating configuration comprises a second resistive heating element defined by the external portion of the resistive heating configuration.

In an embodiment of any of the above, each of the first resistive heating element defined by the internal portion and the second resistive heating element defined by the external portion comprise one of the first type of electrical contact and one of the second type of electrical contact.

In an embodiment of any of the above, the first resistive heating element defined by the internal portion and the second resistive heating element defined by the external portion are formed by the resistive heating layer.

According to an aspect, there is provided a method of forming an article for an aerosol provision device, the method comprising forming a resistive heating configuration comprising a resistive heating layer comprising a resistive heating element configured to heat at least a portion of aerosol generating material to generate an aerosol, a first type of electrical contact and a second type of electrical contact, wherein the resistive heating element is at least a portion of an electrically conductive path between the first type of electrical contact and the second type of electrical contact; disposing an internal portion of the resistive heating configuration in contact with an aerosol generating segment comprising aerosol generating material; and disposing an external portion of the resistive heating configuration in contact with the aerosol generating segment.

According to an aspect, there is provided an article for an aerosol provision device comprising: an aerosol generating segment comprising aerosol generating material; and an aerosol generator comprising: a resistive heating layer comprising a resistive heating element configured to heat at least a portion of the aerosol generating material to generate an aerosol; a support layer configured to support the resistive heating layer; a first type of electrical contact; and a second type of electrical contact; wherein the resistive heating element is at least a portion of an electrically conductive path between the first type of electrical contact and the second type of electrical contact; and wherein the resistive heating element is configured to heat substantially the entire aerosol generating segment.

In an embodiment of any of the above, the aerosol generating segment is at least substantially cylindrical. In an embodiment of any of the above, the resistive heating layer is substantially planar.

In an embodiment of any of the above, the resistive heating layer has a substantially tubular form.

In an embodiment of any of the above, a maximum extent of aerosol generating material away from the resistive heating layer is less than a maximum radial dimension of the article.

In an embodiment of any of the above, a surface area of the resistive heating layer in contact with the aerosol generating segment is greater than the circumferential surface area of the aerosol generating segment.

In an embodiment of any of the above, a planar area of material defining the resistive heating layer in contact with the aerosol generating segment is greater than the circumferential surface area of the aerosol generating segment.

In an embodiment of any of the above, the cross-sectional length of the resistive heating layer in contact with the aerosol generating segment is greater than the circumference of the aerosol generating segment.

In an embodiment of any of the above, the resistive heating element extends at least substantially along a longitudinal length of the aerosol generating segment.

In an embodiment of any of the above, the resistive heating element extends at least a majority of a diametric width of the aerosol generating segment. In an embodiment of any of the above, the resistive heating element extends at least substantially a diametric width of the aerosol generating segment.

In an embodiment of any of the above, the resistive heating element extends in the aerosol generating segment. In an embodiment of any of the above, the resistive heating element extends around the aerosol generating segment. In an embodiment of any of the above, the resistive heating element encircles the aerosol generating segment.

In an embodiment of any of the above, the resistive heating layer defines a heating surface area, wherein the heating surface area is at least 100 mm², optionally at least 200 mm², and optionally at least 300 mm².

In an embodiment of any of the above, the resistive heating element comprises a single resistive heating element. In an embodiment of any of the above, the article comprises a single heating layer. In an embodiment of any of the above, the article comprises a single of the first type of electrical contact; and a single of the second type of electrical contact.

In an embodiment of any of the above, at least a portion of the resistive heating element is embedded in the aerosol generating segment. In an embodiment of any of the above, at least a portion of the resistive heating element at least partially circumscribes the aerosol generating segment.

In an embodiment of any of the above, the resistive heating layer is in external contact with the aerosol generating segment and in internal contact with the aerosol generating segment.

In an embodiment of any of the above, the aerosol generator comprises a resistive heating configuration including the resistive heating layer. In an embodiment of any of the above, each of the internal portion and the external portion of the resistive heating configuration comprise the resistive heating layer. In an embodiment of any of the above, the internal portion and the external portion of the resistive heating configuration are unitary. In an embodiment of any of the above, the internal portion and the external portion are formed from a single sheet of material. In an embodiment of any of the above, the first type of electrical contact and the second type of electrical contact are formed by the single sheet of material.

In an embodiment of any of the above, the internal portion of the resistive heating configuration comprises at least an internal portion of the resistive heating layer. In an embodiment of any of the above, the external portion of the resistive heating configuration comprises at least an external portion of the resistive heating layer. In an embodiment of any of the above, the external portion of the resistive heating element encircles the aerosol generating segment. In an embodiment of any of the above, each of the internal portion and the external portion of the resistive heating configuration comprise the support layer. In an embodiment of any of the above, the internal portion and the external portion of the resistive heating configuration are discrete elements.

According to an aspect, there is provided an aerosol provision system comprising an article of any of those describe above, and an aerosol provision device configured to receive the article.

In an embodiment of any of the above, the system is configured to operate the resistive heating element to enable a plurality of puffs to be drawn by a user.

In an embodiment of any of the above, the system is configured to operate the resistive heating element throughout a plurality of puffs drawn by a user.

According to an aspect, there is provided an article for an aerosol provision device comprising an aerosol generating segment comprising aerosol generating material; and an aerosol generator comprising a resistive heating layer comprising a resistive heating element configured to heat at least a portion of the aerosol generating material to generate an aerosol; a support layer configured to support the resistive heating layer; a first type of electrical contact; and a second type of electrical contact; wherein the resistive heating element is at least a portion of an electrically conductive path between the first type of electrical contact and the second type of electrical contact; and a fold defining a first portion of the resistive heating element in contact with the aerosol generating segment and a second portion of the resistive heating element in contact with the aerosol generating segment.

In an embodiment of any of the above, the first type of electrical contact is on a first side of the fold and wherein the second type of electrical contact is on a second side of the fold.

In an embodiment of any of the above, the first type of electrical contact extends from the first portion of the resistive heating element and the second type of electrical contact extends from the second portion of the resistive heating element.

According to an aspect, there is provided a method of forming an article for an aerosol provision device, the method comprising: forming a resistive heating layer comprising a resistive heating element configured to heat at least a portion of aerosol generating material to generate an aerosol, a first type of electrical contact and a second type of electrical contact, wherein the resistive heating element is at least a portion of an electrically conductive path between the first type of electrical contact and the second type of electrical contact; and disposing the resistive heating layer in contact with an aerosol generating segment comprising aerosol generating material, wherein the resistive heating element is configured to heat substantially the entire aerosol generating segment.

According to an aspect, there is provided an article for an aerosol provision device comprising: an aerosol generating segment comprising aerosol generating material; and an aerosol generator comprising: a resistive heating layer comprising a resistive heating element configured to heat at least a portion of the aerosol generating material to generate an aerosol; a support layer configured to support the resistive heating layer; a first type of electrical contact; a second type of electrical contact; wherein the resistive heating element is at least a portion of an electrically conductive path between the first type of electrical contact and the second type of electrical contact; and wherein at least a portion of the resistive heating element is embedded in the aerosol generating segment.

In an embodiment of any of the above, at least a portion of the support layer is embedded in the aerosol generating segment. In an embodiment of any of the above, at least a portion of the resistive heating element protrudes in the aerosol generating segment.

In an embodiment of any of the above, the first type of electrical contact and the second type of electrical contact are configured to engage with a device electrical connector of the aerosol provision device. In an embodiment of any of the above, the first type of electrical contact and the second type of electrical contact are exposed.

In an embodiment of any of the above, the first type of electrical contact and the second type of electrical contact protrude from an end of the aerosol generating segment. In an embodiment of any of the above, the article comprises a mouth end and an opposing upstream end, wherein the first type of electrical contact and the second type of electrical contact are at the upstream end of the article.

In an embodiment of any of the above, the first type of electrical contact and the second type of electrical contact protrude at the upstream end. In an embodiment of any of the above, the first type of electrical contact and the second type of electrical contact terminate such that they are substantially flush with an upstream end of the aerosol generating segment.

In an embodiment of any of the above, at least one of the first type of electrical contact and the second type of electrical contact is recessed within the aerosol generating segment.

In an embodiment of any of the above, the article comprises a void at the upstream end, wherein the first type of electrical contact and the second type of electrical contact extend in the void. In an embodiment of any of the above, the resistive heating layer is substantially planar. In an embodiment of any of the above, the aerosol generator is spaced from the wrapper. In an embodiment of any of the above, the resistive heating layer extends between diametrically opposing sides of the wrapper.

In an embodiment of any of the above, the resistive heating element is in direct contact with the aerosol generating material. In an embodiment of any of the above, the aerosol generator comprises a first resistive heating panel and a second resistive heating panel. In an embodiment of any of the above, the first resistive heating panel and the second resistive heating panel extend parallel to each other. In an embodiment of any of the above, the first resistive heating panel and the second resistive heating panel sandwich the support layer. In an embodiment of any of the above, the first resistive heating panel is on a first side of the support layer and the second resistive heating panel is on a second side of the support layer. In an embodiment of any of the above, the resistive heating layer comprises the first resistive heating panel and the second resistive heating panel.

In an embodiment of any of the above, the first resistive heating panel and the second resistive heating panel are unitary. In an embodiment of any of the above, the first resistive heating panel and the second resistive heating panel are formed from a single sheet of material. In an embodiment of any of the above, the first resistive heating panel and the second resistive heating panel define the resistive heating element. In an embodiment of any of the above, the resistive heating element extends between the first resistive heating panel and the second resistive heating panel. In an embodiment of any of the above, the resistive heating layer is a first resistive heating layer comprising the first resistive heating panel, and the aerosol generator comprises a second resistive heating layer comprising the second resistive heating panel.

In an embodiment of any of the above, the resistive heating element is a first resistive heating element and the second resistive heating panel comprises a second resistive heating element configured to heat at least a portion of the aerosol generating material to generate an aerosol.

In an embodiment of any of the above, the second resistive heating panel is electrically isolated from the first resistive heating element

In an embodiment of any of the above, the aerosol generator comprises a fold to provide the first resistive heating panel and the second resistive heating panel. In an embodiment of any of the above, the first resistive heating panel faces in a first direction toward the aerosol generating material and the second resistive heating panel faces in a second, different, direction toward the aerosol generating material.

In an embodiment of any of the above, the first type of electrical contact extends from the first resistive heating panel, and the second type of electrical contact extends from the second resistive heating panel. In an embodiment of any of the above, the fold extends perpendicular to the longitudinal axis. In an embodiment of any of the above, the fold defines an end of the aerosol generator.

In an embodiment of any of the above, the fold extends parallel to the longitudinal axis. In an embodiment of the above, the resistive heating element extends across the fold. In an embodiment of the above, the resistive heating element comprises a first resistive heating element portion on a first side of the fold and a second resistive heating element portion on a second side of the fold.

In an embodiment of the above, the first resistive heating element portion and the second resistive heating element portion are formed in series. In an embodiment of the above, the fold defines a first support layer panel of the support layer and a second support layer panel of the support layer. In an embodiment of the above, the first resistive heating element portion is on the first support layer panel of the support layer and the second resistive heating element portion is on the second support layer panel of the support layer. In an embodiment of the above, the first support layer panel and the second support layer panel of the support layer extend in parallel. In an embodiment of the above, the first support layer panel and the second support layer panel of the support layer are mounted together. In an embodiment of the above, the article comprises a wrap. In an embodiment of the above, the wrap includes the resistive heating layer. In an embodiment of the above, the external portion of the resistive heating configuration defines the wrap.

In an embodiment of the above, the aerosol generator comprises an electrical contact panel comprising at least one of the electrical contact of the first type and the electrical contact of the second type and a resistive heating panel comprising the resistive heating element. In an embodiment of the above, a fold defines the resistive heating panel and the electrical contact panel. In an embodiment of any of the above, the resistive heating panel and the electrical contact panel are unitary. In an embodiment of any of the above, the resistive heating panel and the electrical contact panel are formed from a single sheet of material. In an embodiment of any of the above, the resistive heating panel and the electrical contact panel extend parallel to each other.

In an embodiment of any of the above, the resistive heating panel and the electrical contact panel sandwich a portion of the support layer. In an embodiment of any of the above, the resistive heating panel is on a first side of the support layer and the electrical contact panel is on a second side of the support layer. In an embodiment of any of the above, the electrical contact panel comprises the electrical contact of the first type and the electrical contact of the second type.

In an embodiment of any of the above, the electrical contact panel is a first electrical contact panel comprising the electrical contact of the first type and the fold defines a second electrical contact panel comprising the electrical contact of the second type.

In an embodiment of any of the above, the electrical contact of the first type extends to a first edge of the resistive heating layer and the electrical contact of the second type extends to a second edge of the resistive heating layer.

In an embodiment of any of the above, the electrical contact of the first type and the electrical contact of the second type extends adjacent to each other. In an embodiment of any of the above, first and second edge extends parallel to each other. In an embodiment of any of the above, the fold extends perpendicular to the longitudinal axis. In an embodiment of any of the above, the fold defines an end of the aerosol generator. In an embodiment of any of the above, the fold extends parallel to the longitudinal axis.

In an embodiment of any of the above, an electrical contact surface of the at least one of the electrical contact of the first type and the electrical contact of the second type face in an outward direction away from the aerosol generating material and a heating contact face of the resistive heating element panel faces toward the aerosol generating material.

According to an aspect, there is provided a method of forming an article for an aerosol provision device, the method comprising: forming a resistive heating layer comprising a resistive heating element configured to heat at least a portion of aerosol generating material to generate an aerosol, a first type of electrical contact and a second type of electrical contact, wherein the resistive heating element is at least a portion of an electrically conductive path between the first type of electrical contact and the second type of electrical contact; and embedding the resistive heating layer in an aerosol generating segment comprising aerosol generating material.

According to an aspect, there is provided an article for an aerosol provision device comprising: an aerosol generating segment comprising aerosol generating material; a resistive heating layer comprising a resistive heating element configured to heat at least a portion of the aerosol generating material to generate an aerosol; a support layer configured to support the resistive heating layer; a first type of electrical contact; a second type of electrical contact; wherein the resistive heating element is at least a portion of an electrically conductive path between the first type of electrical contact and the second type of electrical contact; and a fold defining a first portion of the resistive heating element in contact with the aerosol generating segment and a second portion of the resistive heating element.

According to an aspect, there is provided an article for an aerosol provision device comprising an aerosol generating segment comprising aerosol generating material; an aerosol generator comprising: a resistive heating layer comprising a resistive heating element configured to heat at least a portion of the aerosol generating material to generate an aerosol; a support layer configured to support the resistive heating layer; a first type of electrical contact; and a second type of electrical contact; wherein the resistive heating element is at least a portion of an electrically conductive path between the first type of electrical contact and the second type of electrical contact; and wherein at least a portion of the resistive heating element at least partially circumscribes the aerosol generating segment.

In an embodiment of any of the above, the aerosol generating segment is encircled by the resistive heating layer. In an embodiment of any of the above, the at least one of the first type of electrical contact and the second type of electrical contact is on an outer side of the aerosol generating segment.

In an embodiment of any of the above, the first type of electrical contact and the second type of electrical contact are configured to engage with a device electrical connector of the aerosol provision device.

In an embodiment of any of the above, the article comprises a wrap, wherein the wrap includes the resistive heating layer.

In an embodiment of any of the above, the article comprises a substrate comprising the resistive heating layer and the support layer. In an embodiment of any of the above, the substrate forms a sheet material. In an embodiment of any of the above, the sheet material is in the form of a wrap.

In an embodiment of any of the above, the resistive heating layer is sandwiched between the aerosol generating segment and the support layer. In an embodiment of any of the above, the resistive heating element at least partially circumscribes the aerosol generating segment. In an embodiment of any of the above, the aerosol generating segment is encircled by the resistive heating element.

In an embodiment of any of the above, the resistive heating element extends at least substantially along an entire longitudinal extent of the aerosol generating segment.

In an embodiment of any of the above, the article comprises a mouth end and an opposing upstream end, wherein the first type of electrical contact and the second type of electrical contact are at the upstream end of the article.

In an embodiment of any of the above, the aerosol generator comprises a fold to define an electrical contact panel comprising at least one of the electrical contact of the first type and the electrical contact of the second type and a resistive heating panel comprising the resistive heating element.

In an embodiment of any of the above, the resistive heating layer has a substantially tubular form. In an embodiment of any of the above, the resistive heating panel and the electrical contact panel are unitary. In an embodiment of any of the above, the resistive heating panel and the electrical contact panel are formed from a single sheet of material.

In an embodiment of any of the above, the resistive heating panel and the electrical contact panel extend parallel to each other. In an embodiment of any of the above, the resistive heating panel and the electrical contact panel sandwich the support layer. In an embodiment of any of the above, the resistive heating panel is on a first side of the support layer and the electrical contact panel is on a second side of the support layer. In an embodiment of any of the above, the electrical contact panel comprises the electrical contact of the first type and the electrical contact of the second type.

In an embodiment of any of the above, the electrical contact panel is a first electrical contact panel comprising the electrical contact of the first type and the fold defines a second electrical contact panel comprising the electrical contact of the second type.

In an embodiment of any of the above, the electrical contact of the first type extends to a first edge of the resistive heating layer and the electrical contact of the second type extends to a second edge of the resistive heating layer.

In an embodiment of any of the above, the electrical contact of the first type and the electrical contact of the second type extends adjacent to each other.

In an embodiment of any of the above, first and second edge extends parallel to each other. In an embodiment of any of the above, the fold extends perpendicular to the longitudinal axis. In an embodiment of any of the above, the fold defines an end of the aerosol generator. In an embodiment of any of the above, the fold extends parallel to the longitudinal axis. In an embodiment of the above, the fold defines a first support layer panel of the support layer and a second support layer panel of the support layer.

In an embodiment of the above, the resistive heating element panel is on the first support layer panel of the support layer and the electrical contact panel is on the second support layer panel of the support layer.

In an embodiment of the above, the first support layer panel and the second support layer panel of the support layer extend in parallel.

In an embodiment of the above, the first support layer panel and the second support layer panel of the support layer are mounted together. In an embodiment of the above, the first support layer panel and the second support layer panel of the support layer are bonded.

In an embodiment of any of the above, an electrical contact surface of the at least one of the electrical contact of the first type and the electrical contact of the second type face in an outward direction away from the aerosol generating segment and a heating contact face of the resistive heating element panel faces in an inward direction toward the aerosol generating material.

In an embodiment of any of the above, the electrical contact panel is circumscribed around the aerosol generating segment. In an embodiment of any of the above, the electrical contact panel overlaps the resistive heating element panel. In an embodiment of any of the above, the article comprises a wrapper circumscribing a portion of the resistive heating layer. In an embodiment of any of the above, the wrapper overwraps at least a portion of the resistive heating element panel. In an embodiment of any of the above, at least a portion of the electrical contact panel is free from being circumscribed by the wrapper. In an embodiment of any of the above, an edge of the electrical contact panel abuts an edge of the wrapper.

In an embodiment of any of the above, the electrical contact panel lies on the same circumferential plane as the wrapper. In an embodiment of any of the above, the first type of electrical contact and the second type of electrical contact are exposed. In an embodiment of any of the above, the wrapper is a paper or card wrapper. In an embodiment of any of the above, the aerosol generator abuts the wrapper. In an embodiment of any of the above, the wrapper defines an outer layer of the article

In an embodiment of any of the above, the support layer comprises at least one of paper and card. In an embodiment of any of the above, the support layer is a sheet material. In an embodiment of any of the above, the support layer is electrically insulative. In an embodiment of any of the above, the support is thermally insulative. In an embodiment of any of the above, the support layer is thermally conductive. In an embodiment of any of the above, a face of the support layer is free from the resistive heating layer. In an embodiment of any of the above, the faces of the support layer are free from contact with the aerosol generating material.

In an embodiment of any of the above, the support layer has a thickness of less than 150 micron, and optionally about 120 microns.

In an embodiment of any of the above, the support layer has a thickness of less than 50 micron, optionally between 20 and 40 microns, and optionally about 30 microns.

In an embodiment of any of the above, the support layer is flexible. In an embodiment of any of the above, the resistive heating layer and the support layer define a substrate. In an embodiment of any of the above, the aerosol generator comprises a laminate comprising the resistive heating layer and the support layer. In an embodiment of any of the above, the area of the support layer corresponds to the area of the resistive heating layer. In an embodiment of any of the above, the article defines a longitudinal axis and the resistive heating layer extends in the direction of the longitudinal axis.

In an embodiment of any of the above, the aerosol generator extends about the longitudinal axis.

In an embodiment of any of the above, the resistive heating layer has a thickness of less than 10 microns, optionally between 4 and 8 microns, and optionally about 6 microns.

In an embodiment of any of the above, the article is at least substantially cylindrical. In an embodiment of any of the above, the aerosol generating segment is at least substantially cylindrical.

In an embodiment of any of the above, the aerosol generating material comprises a plurality of individual pieces of aerosol generating material. In an embodiment of any of the above, the aerosol generating material may be individual pieces of tobacco material. In an embodiment of any of the above, the aerosol generating material comprises a plurality of strips, beads or pellets. In an embodiment of any of the above, the aerosol generating segment comprises a body of material. In an embodiment of any of the above, the aerosol generating material is a non-liquid.

In an embodiment of any of the above, the body of material comprises a tobacco rod. For example, the body of material may comprise shredded tobacco material that is formed into a rod. In some embodiments, the body of material comprises cut rag tobacco that is formed into a rod. In an embodiment of any of the above, the aerosol generating material comprises tobacco material. In an embodiment of any of the above, the aerosol generating material comprises extruded tobacco. In an embodiment of any of the above, the aerosol generating material comprises reconstituted tobacco.

In an embodiment of any of the above, the aerosol generating material comprises shredded tobacco. In an embodiment of any of the above, the aerosol generating material is a solid material. In an embodiment of any of the above, the aerosol generating material comprises nicotine. In an embodiment of any of the above, the aerosol generating material comprises, consists of, or essentially consists of, tobacco. In an embodiment of any of the above, the aerosol generating material is free from tobacco.

In an embodiment of the above, the aerosol generating segment comprises a rod of aerosol-generating material. The rod of aerosol-generating material may be a tobacco rod. In an embodiment of the above, the heating of the article provides a relatively constant release of volatile compounds into an inhalable medium. In an embodiment of the above, the aerosol generating segment is a plug of material.

In an embodiment of the above, the article comprises a mouth end section. In an embodiment of the above, the article comprises a tubular element located between the aerosol generating material and the mouth end section. In an embodiment of the above, the article comprises a ventilation area in the mouth end section. In an embodiment of the above, the mouth end section is configured to be placed between a user's lips.

In an embodiment of the above, the aerosol generating material, the tubular element and the mouth end section are joined by a wrapper. In an embodiment of the above, the mouth end section is formed from a fibrous material. The fibrous material may be a filamentary tow. The filamentary tow may be cellulose acetate. The article may comprise a filtration section located between the tubular element and the mouth end section. The filtration section may be formed from a fibrous material. The fibrous material may be a filamentary tow. The filamentary tow may be cellulose acetate.

In an embodiment of the above, the resistive heating element is formed by at least one of: cutting the resistive heating layer; chemically etching the resistive heating layer; forming or pressing the resistive heating layer; and printing the resistive heating layer. Cutting may include die cutting. The resistive heating element may be formed by an action applied to the resistive heating layer only. In embodiments, the resistive heating element may be formed by an action applied to the resistive heating layer and the support layer, for example an action of cutting the resistive heating layer and the support layer.

In an embodiment of any of the above, the resistive heating layer defines at least a portion of the resistive heating element.

In an embodiment of any of the above, comprising a gap in the resistive heating layer defining at least a portion of the resistive heating element. In an embodiment of any of the above, the gap defines an electrically insulative barrier. In an embodiment of any of the above, the gap defines an insulative barrier. In an embodiment of any of the above, the support layer is free from the gap. In an embodiment of any of the above, the gap extends through both the support layer and the resistive heating layer. In embodiments, the gap is a filled gap, for example with an insulative material.

In an embodiment of any of the above, the resistive heating layer comprising the resistive heating element is preformed and applied to the support layer.

In an embodiment of any of the above, the resistive heating layer comprising the resistive heating element is formed on the support layer.

In an embodiment of any of the above, the resistive heating element is a first heating element and the resistive heating layer forms a second resistive heating element, each resistive heating element providing an electrically conductive path for resistive heating of a portion of the aerosol generating material to generate an aerosol at the respective portion of the aerosol generating layer.

In an embodiment of any of the above, the aerosol generator comprises a single resistive heating element.

In an embodiment of any of the above, the resistive heating layer is in the form of a foil.

According to an aspect, there is provided a method of forming an article for an aerosol provision device, the method comprising: forming a resistive heating layer comprising a resistive heating element configured to heat at least a portion of aerosol generating material to generate an aerosol, a first type of electrical contact and a second type of electrical contact, wherein the resistive heating element is at least a portion of an electrically conductive path between the first type of electrical contact and the second type of electrical contact; and at least partially circumscribing the aerosol generating segment with the resistive heating layer.

According to an aspect, there is provided a non-combustible aerosol provision system according to any of the above wherein the non-combustible aerosol provision system is an aerosol generating material heating system, optionally wherein the non-combustible aerosol provision system is a tobacco heating system.

According to an aspect, there is provided an aerosol generator for an article of an aerosol provision system comprising: an aerosol generating segment comprising aerosol generating material; a resistive heating layer comprising a resistive heating element configured to heat at least a portion of the aerosol generating material to generate an aerosol; a first type of electrical contact; and a second type of electrical contact; wherein the resistive heating element is at least a portion of an electrically conductive path between the first type of electrical contact and the second type of electrical contact.

According to an aspect, there is provided an article for an aerosol provision device comprising an aerosol generator of any of the above.

According to an aspect, there is provided an article of any described above, wherein the article is a consumable of an aerosol generating system.

According to an aspect, there is provided an aerosol provision device configured to receive an aerosol generator or an article for an aerosol provision device of any of the above.

According to an aspect, there is provided an article of any described above, and an aerosol provision device configured to receive the article.

According to an aspect, there is provided a blank for forming an aerosol generator of an article of any described above.

### BRIEF DESCRIPTION OF THE DRAWINGS

Various embodiments will now be described, by way of example only, with reference to the accompanying schematic drawings, in which:

FIG. 1 is a schematic side view of an aerosol provision system including an aerosol provision device and an article;

FIG. 2 is a schematic part cross-sectional view of an article comprising aerosol generating material of the aerosol provision system of FIG. 1;

FIG. 3 is a schematic part cross-sectional view of the article of FIG. 2;

FIG. 4 is a schematic block diagram of an aerosol provision system such as the system shown in FIG. 1;

FIG. 5 is a schematic plan view of a heating element of the aerosol generator of FIG. 3;

FIG. 6 is a schematic perspective view of the aerosol generator of FIG. 3;

FIG. 7 is a schematic plan view of an aerosol generating layer for use in the aerosol generator of FIG. 6;

FIG. 8 is a schematic perspective view of another aerosol generator of an article of the aerosol provision system of FIG. 1;

FIG. 9 is a schematic perspective view of an aerosol generating layer of the article;

FIG. 10 is a schematic perspective view of an aerosol generating layer of the article;

FIG. 11 is a schematic cross-sectional view of an aerosol generator such as the aerosol generator shown in FIG. 6;

FIG. 12 is a flow chart showing a method of forming an aerosol generator, such as the aerosol generator of FIG. 6;

FIG. 13 is a schematic perspective view of a resistive heating layer of an aerosol generator being formed;

FIG. 14 is a flow chart showing a method of forming an aerosol generator, such as the aerosol generator of FIG. 6;

FIG. 15 is a flow chart showing a method of forming an aerosol generator, such as the aerosol generator of FIG. 6; and

FIG. 16 is a flow chart showing a method of forming an aerosol generator, such as the aerosol generator of FIG. 6.

### DETAILED DESCRIPTION

As used herein, the term “delivery mechanism” is intended to encompass systems that deliver a substance to a user, and includes: non-combustible aerosol provision systems that release compounds from an aerosolisable material without combusting the aerosolisable material, such as electronic cigarettes, tobacco heating products, and hybrid systems to generate aerosol using a combination of aerosolisable materials; and articles comprising aerosolisable material and configured to be used in one of these non-combustible aerosol provision systems.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the disclosure relates to a component for use in a combustible aerosol provision system, such as a filter, a filter rod, a filter segment, a tobacco rod, a spill, an aerosol-modifying agent release component such as a capsule, a thread, or a bead, or a paper such as a plug wrap, a tipping paper or a cigarette paper.

According to the present disclosure, a “non-combustible” aerosol provision system is one where a constituent aerosol-generating material of the aerosol provision system (or component thereof) is not combusted or burned in order to facilitate delivery of at least one substance to a user.

As used herein, the term “aerosol-generating material” (which is sometimes referred to herein as an aerosolisable material) is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

In some embodiments, the substance to be delivered comprises an active substance (sometimes referred to herein as an active compound).

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

In embodiments, the aerosol-generating material comprises a plurality of aerosol-generating films. In embodiments, the aerosol-generating film comprises a plurality of aerosol-generating film regions. Such plurality of aerosol-generating films and/or plurality of aerosol-generating film regions may have different properties, for example at least one of different compositions, thicknesses, density, active substances and/or flavours, one or more aerosol-former materials, and optionally one or more other functional material.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

The slurry may be heated to remove at least about 60 wt %, 70 wt %, 80 wt %, 85 wt % or 90 wt % of the solvent.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-Substitute generating material is formed from a slurry). In some embodiments, the solvent may be water.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may comprise a conductor which can be heated by the passage of an electrical current through the conductor.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

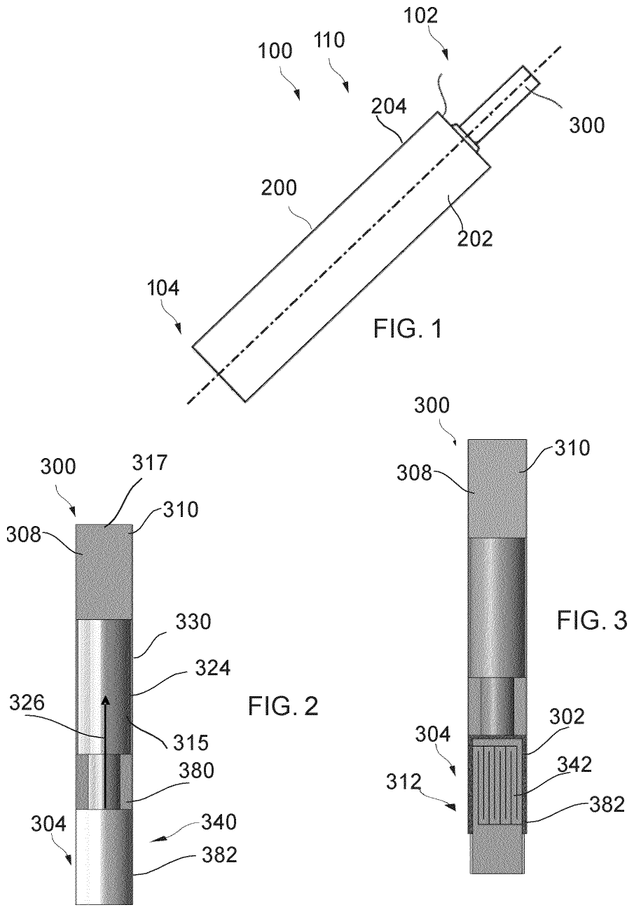

FIG. 1 shows a schematic view of an aerosol provision system 100. The aerosol provision system 100 comprises an aerosol provision device 200 and an article 300 comprising aerosol generating material 302. The aerosol provision device has a tubular configuration to receive an article 300. In embodiments, the device 200 has a circular cross-section, that is, the device 200 is cylindrical. Other formats are envisaged. The article 300 is shown in FIG. 2 removed from the aerosol provision device 200. An aerosol generator 304 of the article 300 is shown in, for example, FIGS. 3, 6 and 8.

As shown in FIGS. 1 to 10, the article 300 is shown in a cylindrical configuration. Although the article 300 of FIGS. 1 to 10 is shown in a cylindrical form having a substantially circular cross section, it will be understood that cylindrical or tubular is not restricted to a circular cross-section, and may include other shapes of articles. Formation of the aerosol generator 304 of any of the foregoing embodiments may include moving an arrangement in a planar form into a tubular form.

Other arrangements are envisaged in which the article 300 has a planar configuration such that an exterior of the article has a length, a width perpendicular to the length, and a depth perpendicular to each of the length and the width, wherein the length is greater than or equal to the width, and wherein the width is greater than the depth.

The article 300 comprises the aerosol generator 304. The aerosol generator 304 is configured to generate an aerosol from the aerosol generating material 302 upon operation of the aerosol provision system 100, as will be described in detail below.

The aerosol generator 304 comprises a resistive heating layer 340 and a resistive heating element 342, which are discussed in detail below.

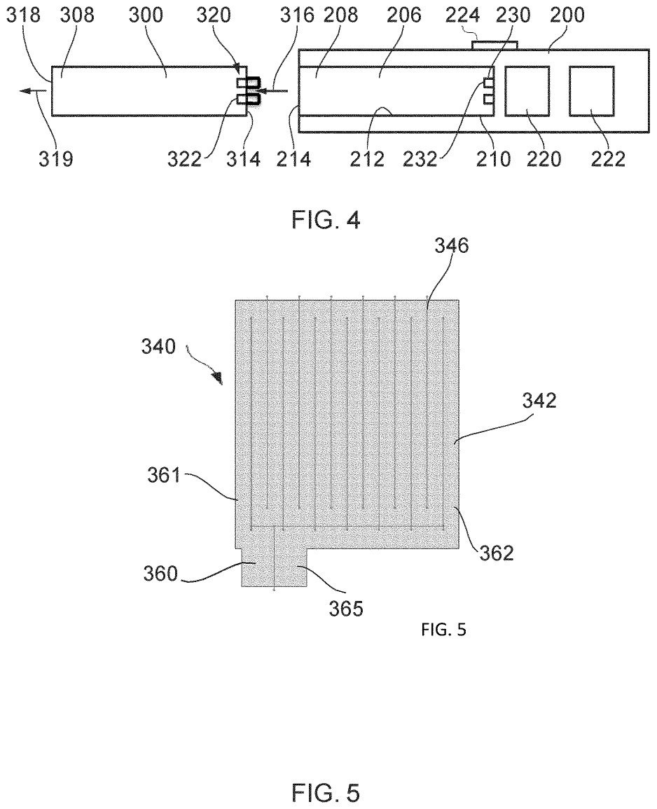

The article 300 comprises an aerosol generating segment 382. The aerosol generating segment 382 comprises the aerosol generating material 302. The aerosol generating segment is in fluid communication with a tubular member 380, in which aerosol generated by heating the aerosol generating material 302 travels through in use, when a user operate the system 100 and draws on mouth piece 310 (refer to FIG. 4). The tubular member 380 may be composed of paper or card. An aerosol generator 304 is disposed to heat the aerosol generating segment 382. A resistive heating layer 340 is disposed with the aerosol generating segment 382.

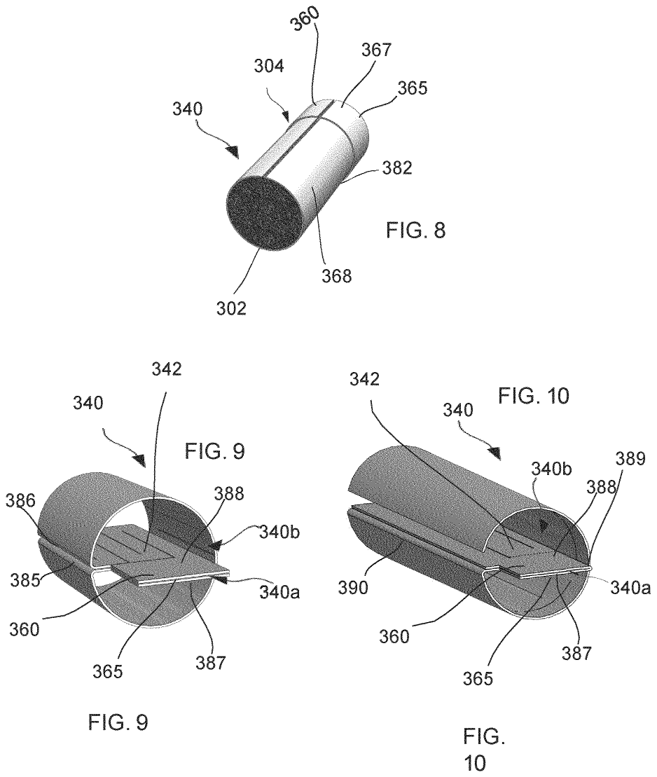

The aerosol generating material 302 may be in the form of a rod. In embodiments, such as those of FIGS. 2 and 3 the rod is wrapped in a plug wrap. In embodiments, the plug wrap a non-porous plug wrap. Other embodiments are envisaged wherein the plug wrap is porous. In embodiments the rod is wrapped with the aerosol generator 304, for example as shown in FIG. 8.

The aerosol generating material 302 may comprise tobacco material as described herein, which includes a tobacco component.

In the tobacco material described herein, the tobacco component may contain paper reconstituted tobacco. The tobacco component may also contain leaf tobacco, extruded tobacco, and/or bandcast tobacco.

The aerosol generating material 302 can comprise reconstituted tobacco material having a density of less than about 700 milligrams per cubic centimetre (mg/cc). Such tobacco material has been found to be particularly effective at providing an aerosol generating material which can be heated quickly to release an aerosol, as compared to denser materials.

The tobacco material may be provided in the form of cut rag tobacco. The cut rag tobacco can be formed from a mixture of forms of tobacco material, for instance a mixture of one or more of paper reconstituted tobacco, leaf tobacco, extruded tobacco and bandcast tobacco.

In embodiments, the tobacco material comprises paper reconstituted tobacco or a mixture of paper reconstituted tobacco and leaf tobacco. In the tobacco material described herein, the tobacco material may contain a filler component. The filler component is generally a non-tobacco component, that is, a component that does not include ingredients originating from tobacco. The filler component may be a non-tobacco fibre such as wood fibre or pulp or wheat fibre. The filler component may also be an inorganic material such as chalk, perlite, vermiculite, diatomaceous earth, colloidal silica, magnesium oxide, magnesium sulphate, magnesium carbonate. The filler component may also be a non-tobacco cast material or a non-tobacco extruded material. The filler component maybe present in an amount of 0 to 20% by weight of the tobacco material, or in an amount of from 1 to 10% by weight of the composition. In some embodiments, the filler component is absent. In the tobacco material described herein, the tobacco material contains an aerosol-former material. In this context, an “aerosol-former material” is an agent that promotes the generation of an aerosol. An aerosol-former material may promote the generation of an aerosol by promoting an initial vaporisation and/or the condensation of a gas to an inhalable solid and/or liquid aerosol.

In some embodiments, an aerosol-former material may improve the delivery of flavour from the aerosol generating material. In general, any suitable aerosol-former material or agents may be included in the aerosol generating material of the invention, including those described herein.

Other suitable aerosol-former materials include, but are not limited to: a polyol such as sorbitol, glycerol, and glycols like propylene glycol or triethylene glycol; a non-polyol such as monohydric alcohols, high boiling point hydrocarbons, acids such as lactic acid, glycerol derivatives, esters such as diacetin, triacetin, triethylene glycol diacetate, triethyl citrate or myristates including ethyl myristate and isopropyl myristate and aliphatic carboxylic acid esters such as methyl stearate, dimethyl dodecanedioate and dimethyl tetradecanedioate. In some embodiments, the aerosol-former material may be glycerol, propylene glycol, or a mixture of glycerol and propylene glycol. Glycerol may be present in an amount of from 10 to 20 % by weight of the tobacco material, for example 13 to 16 % by weight of the composition, or about 14% or 15% by weight of the composition. Propylene glycol, if present, maybe present in an amount of from 0.1 to 0.3% by weight of the composition.

The aerosol-former material may be included in any component, for example any tobacco component, of the tobacco material, and/or in the filler component, if present. Alternatively or additionally the aerosol-former material may be added to the tobacco material separately. In either case, the total amount of the aerosol-former material in the tobacco material can be as defined herein.

The tobacco material can contain between 10% and 90% by weight tobacco leaf, wherein the aerosol-former material is provided in an amount of up to about 10% by weight of the leaf tobacco. To achieve an overall level of aerosol-former material between 10% and 20% by weight of the tobacco material, it has been advantageously found that this can be added in higher weight percentages to another component of the tobacco material, such as reconstituted tobacco material. The tobacco material described herein contains nicotine. The nicotine content is from 0.5 to 1.75% by weight of the tobacco material, and maybe, for example, from 0.8 to 1.5% by weight of the tobacco material. Additionally or alternatively, the tobacco material contains between 10% and 90% by weight tobacco leaf having a nicotine content of greater than 1.5% by weight of the tobacco leaf. It has been advantageously found that using a tobacco leaf with nicotine content higher than 1.5% in combination with a lower nicotine base material, such as paper reconstituted tobacco, provides a tobacco material with an appropriate nicotine level but better sensory performance than the use of paper reconstituted tobacco alone. The tobacco leaf, for instance cut rag tobacco, can, for instance, have a nicotine content of between 1.5% and 5% by weight of the tobacco leaf.

The tobacco material described herein can contain an aerosol modifying agent, such as any of the flavours described herein. In one embodiment, the tobacco material contains menthol, forming a mentholated article.

In the compositions described herein, where amounts are given in % by weight, for the avoidance of doubt this refers to a dry weight basis, unless specifically indicated to the contrary. Thus, any water that may be present in the tobacco material, or in any component thereof, is entirely disregarded for the purposes of the determination of the weight %. The water content of the tobacco material described herein may vary and may be, for example, from 5 to 15% by weight. The water content of the tobacco material described herein may vary according to, for example, the temperature, pressure and humidity conditions at which the compositions are maintained. The water content can be determined by Karl-Fisher analysis, as known to those skilled in the art.

On the other hand, for the avoidance of doubt, even when the aerosol-former material is a component that is in liquid phase, such as glycerol or propylene glycol, any component other than water is included in the weight of the tobacco material. However, when the aerosol-former material is provided in the tobacco component of the tobacco material, or in the filler component (if present) of the tobacco material, instead of or in addition to being added separately to the tobacco material, the aerosol-former material is not included in the weight of the tobacco component or filler component, but is included in the weight of the “aerosol-former material” in the weight % as defined herein. All other ingredients present in the tobacco component are included in the weight of the tobacco component, even if of non-tobacco origin (for example non-tobacco fibres in the case of paper reconstituted tobacco).

In an embodiment, the tobacco material comprises the tobacco component as defined herein and the aerosol-former material as defined herein. In an embodiment, the tobacco material consists essentially of the tobacco component as defined herein and the aerosol-former material as defined herein. In an embodiment, the tobacco material consists of the tobacco component as defined herein and the aerosol-former material as defined herein.

Paper reconstituted tobacco is present in the tobacco component of the tobacco material described herein in an amount of from 10% to 100% by weight of the tobacco component. In embodiments, the paper reconstituted tobacco is present in an amount of from 10% to 80% by weight, or 20% to 70% by weight, of the tobacco component. In a further embodiment, the tobacco component consists essentially of, or consists of, paper reconstituted tobacco. In embodiments, leaf tobacco is present in the tobacco component of the tobacco material in an amount of from at least 10% by weight of the tobacco component. For instance, leaf tobacco can be present in an amount of at least 10% by weight of the tobacco component, while the remainder of the tobacco component comprises paper reconstituted tobacco, bandcast reconstituted tobacco, or a combination of bandcast reconstituted tobacco and another form of tobacco such as tobacco granules.

Paper reconstituted tobacco refers to tobacco material formed by a process in which tobacco feedstock is extracted with a solvent to afford an extract of solubles and a residue comprising fibrous material, and then the extract (usually after concentration, and optionally after further processing) is recombined with fibrous material from the residue (usually after refining of the fibrous material, and optionally with the addition of a portion of non-tobacco fibres) by deposition of the extract onto the fibrous material. The process of recombination resembles the process for making paper.

The paper reconstituted tobacco may be any type of paper reconstituted tobacco that is known in the art. In a particular embodiment, the paper reconstituted tobacco is made from a feedstock comprising one or more of tobacco strips, tobacco stems, and whole leaf tobacco. In a further embodiment, the paper reconstituted tobacco is made from a feedstock consisting of tobacco strips and/or whole leaf tobacco, and tobacco stems. However, in other embodiments, scraps, fines and winnowings can alternatively or additionally be employed in the feedstock.

The paper reconstituted tobacco for use in the tobacco material described herein may be prepared by methods which are known to those skilled in the art for preparing paper reconstituted tobacco.

The aerosol provision system 100 is elongate, extending along a longitudinal axis. The aerosol provision system 100 has a proximal end 102, which will be closest to the user (e.g. the user's mouth) when in use by the user to inhale the aerosol generated by the aerosol provision system 100, and a distal end 104 which will be furthest from the user when in use. The aerosol provision device 200 shown in FIG. 1 has a cylindrical form. Other embodiments are envisaged wherein the aerosol provision device 200 may be in a square or rectangular form.

The article 200 shown in FIG. 2 also has a corresponding cylindrical form to the aerosol provision device 200. Other embodiments are envisaged wherein the article 200 comprises a planar form i.e., the article 200 is a flat consumable.

The proximal end may also be referred to as the “mouth end”. The aerosol provision system 100 accordingly defines a proximal direction, which is directed towards the user when in use. Further, the aerosol provision system 100 likewise defines a distal direction, which is directed away from the user when in use. The terms ‘proximal’ and ‘distal’ as applied to features of the system 100 will be described by reference to the relative positioning of such features with respect to each other in a proximal-distal direction along a longitudinal axis.

The article 300 is received by the aerosol provision device 200. The configuration of the article 300 and the aerosol provision device 200 may vary. In the present embodiment, the aerosol provision device 200 comprises a device body 202. The device has a housing 204 enclosing components of the device 200. An article receiving portion 206, sometimes referred to as a device chamber, as shown in FIG. 4 is configured to receive a portion of the article 300. A proximal end 308 of the article protrudes from the device 200 when the article 300 is received in the device chamber 206. The proximal end can also be referred to as the mouth end. A receptacle 208 defines the chamber 206.

The receptacle 208 comprises a receptacle base 210 and a receptacle peripheral wall 212. The configuration of the receptacle 208 may vary in dependence on the configuration of the article 300, for example, the receptacle 208 is correspondingly cylindrical to receive the cylindrical article 200 as discussed with reference to FIG. 2.

One or more user-operable control elements 224, such as a button or switch, which can be used to operate the aerosol provision system 100 may be provided on the aerosol provision device 200. For example, a user may activate the system 100 by pressing the control element 224. The one or more user-operable control elements may be omitted. In embodiments, the aerosol provision system 100 is operated by another user action, for example puff activated by a user drawing air through the system.

The aerosol provision device 200 comprises an opening 214 at the proximal end, leading into the device chamber 206. The opening 214 is provided in one end, through which the article 300 can be inserted. In embodiments, the article 300 may be fully or partially inserted into the device 200. The configuration of the device 200 may vary, for example the opening may be in a longitudinal side wall of the device 200, and/or may be closed by another feature of the device 200 during use. In the present configuration, the article 300 defines a mouthpiece 310 at the proximal end 308. In other embodiments, the device 200 defines the mouthpiece. The user places their mouth over the mouthpiece during use.

The device 200 defines the longitudinal axis along which an article 300 may extend when inserted into the device 200. The opening 214 is aligned on the longitudinal axis. The longitudinal axis may be an axis along which the article 300 is inserted into the device 200. The longitudinal axis may be considered to be a receiving axis of the device 200. The article 300 may similarly have a longitudinal axis along which it is inserted into the device and this axis may be considered to be an insertion axis.

The aerosol provision device 200 comprises a power source 220. The power source 220 may be a battery, for example a rechargeable battery. The device 200 also comprises a control circuit 222, acting as a controller, comprising a processor and a memory.

As discussed in detail below, a heating system 110 is configured to heat the aerosol generating material 302 of the article 300. The article 300 in embodiments is a consumable, and is interchangeable with other articles 300. The heating system 110 comprises the aerosol generator 304. The heating system 110 comprises other components of the aerosol provision system 100 including components of the article 300 and the aerosol provision device 200, for example the power source 220 and the control circuit 222.

The aerosol generator 304 forms part of the article 300. The aerosol generator 304 comprises a heating arrangement 312 configured to heat the aerosol generating material 302. The aerosol generating material 302 may be referred to as aerosolisable material.

The heating arrangement 312 is a resistive heating arrangement. The or each heating element in embodiments is a resistive heating element, as described in detail below. In such arrangements the heating system 110 comprises a resistive heating generator including components to heat the heating arrangement 312 via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement 312 comprises electrical contacts for supplying electrical current to the resistive material. The provision of a resistive heating arrangement 312 allows for a compact arrangement. Resistive heating provides an efficient configuration.

In the use of the aerosol provision system 100, air is drawn into an upstream end 314 of the article 300, as indicated by arrow 316. The article comprises the mouth end 308, and the opposing upstream end 314. The air flow to the air inlet 314 of the article 300 may be defined, for example by at least one of an air path through the device 200, an air path external to the device 200, and an air path between the device 200 and the article 300. An aerosol generated by the aerosol generator 304 exits the device at an aerosol outflow 318, as indicated by arrow 319. In embodiments the aerosol outflow 318 is in the mouthpiece of the article 300, such that the aerosol is drawn directly from the article 300 into the mouth of a user of the system 100.

In some example embodiments, the aerosol provision system comprises two main components, namely a control section forming a reusable part and a consumable section forming a replaceable or disposable part which may be referred to as a replaceable or disposable article or cartridge. As described herein, the aerosol provision device 200 forms a control section and the article 300 forms the consumable section. In the use of the aerosol generating system, the control section and the consumable part may be releasably connected at an interface. The consumable part may be removable and replaceable, for example when the consumable part is used, with the control section being re-used with a different consumable part.

The aerosol provision system 100 as shown is provided by way of example only and is highly schematic. Different aerosol generating devices and other devices may be used in example implementations of the principles described here.

As shown schematically in FIG. 4, and described in detail below, the article 300 has an article electrical contact configuration 320. The electrical contact configuration 320 in embodiments is formed by the aerosol generator 304. The electrical contact configuration 320 comprises heater electrical contacts 322. The heater electrical contacts 322 may also be known as heater or article contacts. The heater electrical contacts 322 shown in FIG. 4 extend from the article 300. The heater electrical contacts 322 extend from the upstream end of the article 300. The heater electrical contacts 322 protrude from the upstream end of the article 300. The aerosol provision device 200 comprises an electrical connector 230. The electrical connector 230 comprises connector electrical contacts 232. The connector electrical contacts 232 may also be known as connector or device contacts. The article electrical contact configuration 320 is configured to electrically communicate with the device electrical connector 230.

The configuration of the article 300 may vary. As described herein, the article is a cylindrical article. The cylindrical article may be elongate in the longitudinal direction.

Other embodiments are envisaged wherein the article is a flat article, for example, the exterior of the article 300 may have a length, a width perpendicular to the length, and a depth perpendicular to each of the length and the width, wherein the length may be greater than or equal to the width, and wherein the width may be greater than the depth.

The article 300 comprises a body 324. The body 324 includes the components of the article 300. The body 324 is cylindrical. The body 324 defines a flow path 326 through the article 300 along which air and/or aerosol can flow.

The body 324 comprises a filter 317. The filter segment 317 may be formed of any filter material sufficient to remove one or more volatilized compounds from heated volatilized components from the aerosol generating material 302. In one example the filter segment is made of a mono-acetate material, such as cellulose acetate. The filter segment provides cooling and irritation-reduction from the heated volatilized components without depleting the quantity of the heated volatilized components to an unsatisfactory level for a user.

The density of the cellulose acetate tow material of the filter segment 317 controls the pressure drop across the filter segment, which in turn controls the draw resistance of the article 300. Therefore, the selection of the material of the filter segment is important in controlling the resistance to draw of the article 300. In addition, the filter segment performs a filtration function in the article 300.

In one example, the filter segment 317 is made of an 8Y15 grade of filter tow material, which provides a filtration effect on the heated volatilized material, whilst also reducing the size of condensed aerosol droplets which result from the heated volatilized material.

The presence of the filter segment provides an insulating effect by providing further cooling to the heated volatilized components. This further cooling effect reduces the contact temperature of the user's lips on the surface of the filter segment. In one example, the filter segment is between 6 mm to 10 mm in length, suitably 8 mm.

The number of aerosol generators 304 may differ. The aerosol generating material 302 is in the flow path 326. In embodiments the article 300 comprises a single aerosol generator 304.

The aerosol generating segment 382 abuts the tubular member 380. The components of the body 324 are secured by a wrapper 330. In embodiments the tubular member 380 is omitted.

The wrapper 330 is disposed around the aerosol generating segment 362. In an embodiment, the wrapper extends around the length of the article 300. In an embodiment, the wrapper 330 circumscribes the aerosol generating segment. The wrapper 330 is a paper or card wrapper.

In embodiments, as shown in the Figures, the article 300 has a cylindrical configuration. Other configurations are envisaged, such as flat or tubular configuration, for example, the article may be square or rectangular.

FIG. 3 shows a cross sectional view of the aerosol generating segment 382 of the article 300 as discussed with reference to FIG. 2, according to an embodiment. In this embodiment, the aerosol generator 304 comprises the resistive heating layer 340. The resistive heating layer 340 defines a resistive heating element 342 that is embedded within the aerosol generating material 302.

In embodiments, the resistive heating element 342 is configured to heat substantially the entire aerosol generating segment 382 comprising the aerosol generating material 302. In embodiments, the maximum extent of aerosol generating material 302 away from the resistive heating layer 340 is less than a maximum radial dimension of the article 300, for example, the maximum distance aerosol generating material 302 is located away from a resistive heating element 342 is less than the diameter of the article 300.

In embodiments, the resistive heating element 342 extends at least substantially along a longitudinal length of the aerosol generating segment 382. In embodiments, the resistive heating element 342 extend at least a majority of a diametric width of the aerosol generating segment 382. In embodiments, the resistive heating element 342 extends at least substantially a diametric width of the aerosol generating segment 382. In embodiments, the resistive heating element 342 extends in the aerosol generating segment 382.

FIG. 5 is a schematic plan view of a resistive heating layer 340 comprising a resistive heating element 342 of the aerosol generator 304, for example of FIGS. 3 and 10. FIG. 5 shows one of the resistive heating elements 342. In embodiments, the resistive heating layer 340 comprises a plurality of resistive heating elements 342. In the present embodiment, the resistive heating layer 340 comprises a single resistive heating element 342. The resistive heating element 342 comprises a resistive heating path. The resistive heating path is formed by an electrically conducting path. The resistive heating path is non-straight. The resistive heating path is convoluted. The configuration of the resistive heating path may vary. The electrical resistance of the heating element 342 may be dependent on the nature of the resistive heating path in the conductive layer, for example the length, width, thickness and arrangement of the path, as well as the material.

The resistive heating element 342 extends between a first type of electrical contact 360 and a second type of electrical contact 365. The first type of electrical contact 360 is configured to provide a positive contact and the second type of electrical contact 365 is configured to provide a negative contact. Electrical current flows between the first type of electrical contact 360 and the second type of electrical contact 365 through the path. The contact arrangement may be reversed. The first and second types of electrical contacts 360, 365 are heater electrical contacts 322. The first and second types of electrical contacts 360, 365 form at least part of the article electrical contact configuration 320.

The meandering or serpentine nature of the path of the resistive heating element 342 is such that the electrical resistance of the path is increased when compared with a straight path between the first and second type of electrical contacts.

The resistive heating layer 340 may comprise the first type of electrical track 361 extending from the resistive heating element 342. The first type of electrical track 361 comprises the first type of electrical contact 360. The electrical contact 360 of the first type is configured to electrically connect with the device electrical connector 230. The first type of electrical contact 360 comprises a first type of exposed contact region 362. The first type of exposed contact region 362 is exposed on the article for direct connection with the device electrical connector 230.

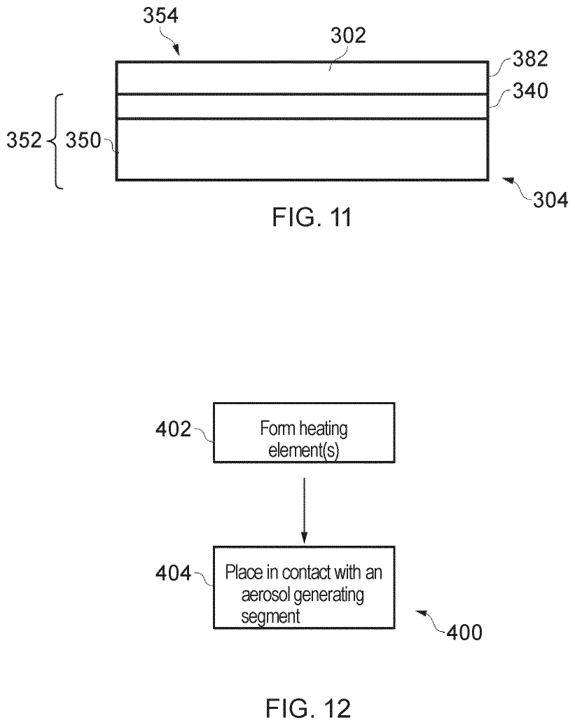

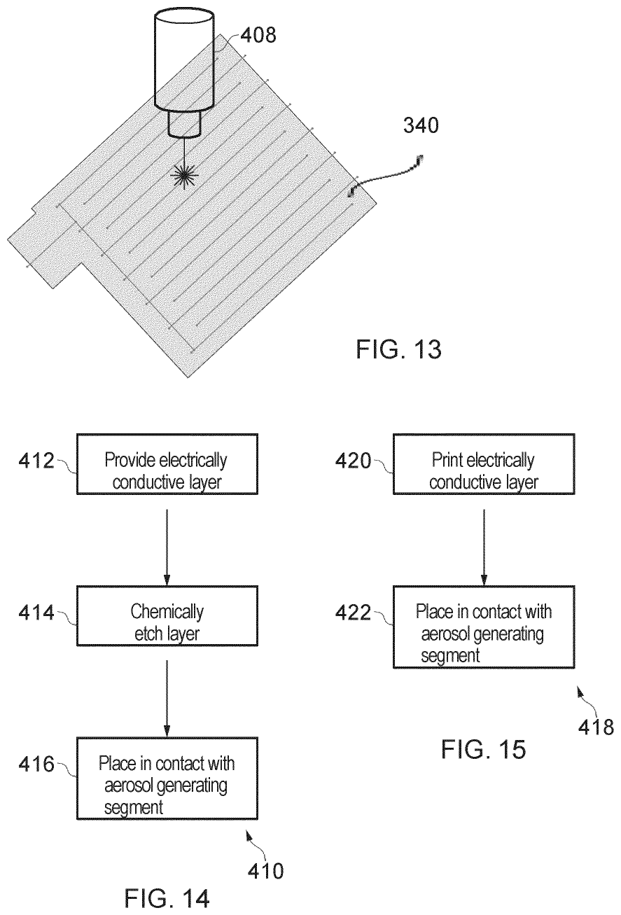

As discussed in detail below, the conducting path of the resistive heating element 342 in embodiments is created by defining at least one electrically insulative barrier 346 in the resistive heating layer 340. In embodiments, the electrically insulative barrier 346 is formed by cutting electrically insulative barrier restrictions (i.e. electrically insulating portions), such as gaps, channels or slots into a sheet formed of electrically conductive material to form the resistive heating layer 340. In embodiments, the resistive heating layer 340 is preformed to define the or each resistive heating element 342 and then applied to a support 350 (refer to FIG. 11). In embodiments, the resistive heating layer 340 is applied to the support 350, and the or each resistive heating element 342 then defined in the resistive heating layer 340. The or each resistive heating element 342 defining the resistive heating layer 340 may be a printed heater. The insulative barrier may be an air gap. In embodiments, the insulative barrier is a filled gap, for example filled with an insulative material. The barrier defines a barrier to electrical conduction across the barrier.

The support layer 350 is flexible. The support layer 350 may have a thickness of less than 150 micron. The thickness may be about 120 microns. Other embodiments are envisaged in which the thickness is less than 50 microns, for example, 30 microns. By providing the support layer in a wrapped configuration and/or in an embedded configuration as described herein it is possible to minimise the thickness of the support layer to provide support to the resistive heating layer predominantly during assembly, with additional support being provided by the aerosol generating segment once assembled. The support layer may also be embedded within the aerosol generating segment 382.

The or each resistive heating element 342 defining the resistive heating layer 340 may be formed by a cutting action. Cutting may include die cutting. The resistive heating element may be formed by an action applied to the resistive heating layer only. In embodiments, the resistive heating element may be formed by an action applied to the resistive heating layer and the support layer, for example an action of cutting the resistive heating layer and the support layer.

The at least one electrically insulative barrier 346 defines the first and second types of electrical track 361, 366.

In some embodiments, the tracks of the or each resistive heating element 342 have a width in the region of 0.5 mm to 1 mm (two example prototypes have widths of 0.93 mm and 0.72 mm respectively) and gaps between the tracks of less than about 0.25 mm (the same two example prototypes have gaps of 0.2 mm and 0.05 mm respectively). The or each resistive heating element 342 may have overall dimensions of the order of 10 mm×10 mm. Other dimensions are possible in other example embodiments. By forming the or each resistive heating element 342 of these dimensions from an aluminium foil of having a thickness of 0.006 mm and an electrical resistivity of between 2 and 6 μOhmcm, the resistance of the path has been calculated to be of the order of 1 Ohm. In one example embodiment, the resistance was measured at between 0.83 and 1.31 Ohms.

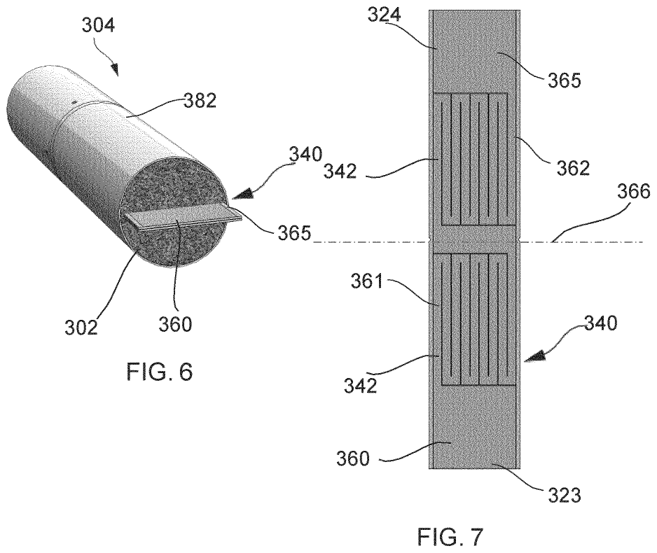

FIG. 6 shows a schematic perspective view of the aerosol generating segment 382 of FIGS. 2 and 3. The aerosol generator 304 is embedded within the aerosol generating segment 382. The resistive heating layer 340 and in turn the resistive heating element 342 is also embedded within the aerosol generating material 302. The resistive heating element 342 is encompassed by the aerosol generating material 302. The resistive heating element 342 and its component parts as shown in FIG. 5 is embedded with the aerosol generating material 302. The resistive heating element 342 may be in direct contact with the aerosol generating material.

The resistive heating layer 340 shown in FIG. 6 is planar.

The electrical contact of the first type 360 and the electrical contact of the second type 365 of the resistive heating element 342 extend from the article 300. The electrical contact of the first type 360 and the electrical contact of the second type 365 extend from the upstream end of the article 300. The electrical contact of the first type 360 and the electrical contact of the second type 365 protrude from the upstream end of the article. Other embodiments are envisaged wherein the electrical contact of the first type 360 and the electrical contact of the second type 365 terminate such that they are substantially flush with an upstream end of the aerosol generating segment 382. The electrical contact of the first type 360 and the electrical contact of the second type 365 may be recessed within the aerosol generating component 382 and the aerosol generating material 302. In embodiments, the aerosol generating material 302 may comprise a void at the upstream end, wherein the electrical contact of the first type 360 and the electrical contact of the second type 365 extend in the void. In embodiments, the void is created by wrapper 330 extending out from the upstream end of the aerosol generating segment 382.

In embodiments the resistive heating layer 340 defines a single resistive heating panel comprising the resistive heating element 342.

The article 300 defines a longitudinal axis. In embodiments, such as the one shown in FIG. 6, the aerosol generator 304, the aerosol generating layer 340 and the resistive heating element 342 extend along the longitudinal axis.

In embodiments the aerosol generator 304 comprises a first panel 323 and a second panel 324 (refer to FIG. 7). The first panel 323 and the second panel 324 may be disposed on top of one another, for example, an underside of the first panel 323 can be directly adjacent an underside of the second panel 324. The underside of panels 323, 324 can extend parallel to one another. The resistive heating element 342 is directed towards the aerosol generating material 302.

In embodiments, the panels may be unified, such an embodiment is shown in FIG. 7. In other embodiments, the panels are distinct elements. The panels are formed from one sheet 380. The panels are formed by folding the sheet along a fold line 366, such that the panel 323 faces in an opposite direction to panel 324. The fold 366 extends perpendicularly to the longitudinal axis. Other embodiments are envisaged where the fold extends longitudinally to the latitudinal axis.

The resistive heating element 342 extends across both of the panels 323, 324. The resistive heating element 342 extends across the fold. In embodiments, each of the panels 323, 324 comprise a resistive heating element or a plurality of resistive heating element 342. When each of the panels 323, 324 comprise a resistive heating element 342, the resistive heating elements 342 may be arranged in a series circuit.

The panels 323, 324 are in direct contact with the aerosol generating material. The support layer 350 is disposed between the first panel 323 and the second panel 324. The support layer 350 may be thermally conducting and electrically insulating. The panels 323, 324 are electrically isolated from one another.

In embodiments, the fold defines a first support layer panel of the support layer 350 and a second support layer panel of the support layer 350. In such embodiments, the first panel 323 is supported by the first support layer panel of the support layer 350 and the second panel 324 is supported by the second support layer panel of the support layer 350. The first support layer panel and the second support layer panel of the support layer may extend in parallel and may be mounted together, for example, by bonding.

In embodiments where there is only a single panel arrangement one side of the heating arrangement with the resistive heating element 342 is in direct contact with the aerosol generating material 302. In embodiments, the support layer is omitted such that both sides of the resistive heating element are exposed to the aerosol generating material. In embodiments with a fold, the support layer 350 is sandwiched between opposing panels including portions, or in embodiments separate resistive heating elements, with heating element tracks extending on both sides. As such, the panel area of the resistive heating elements 342 that can be in direct contact with the aerosol generating 302 is twice that of a single panel arrangement. The double panel arrangement can therefore lead to an increased heat transfer to the aerosol generating material 302.

In embodiments each of the panels 323, 324 may comprise a plurality of the resistive heating elements 342.

In the embodiment shown in FIG. 7, the first panel 323 comprises the electrical contact of the first type 360 and the second panel 324 comprises the electrical contact of the second type 365. In embodiments, the configuration may be in reverse. In embodiments where the panels are not unified and formed from a single sheet, each of the panels 324, 324 may comprise at least one of the electrical contact of the first type and the electrical contact of the second type.

In any of the above embodiments, the or each resistive heating element(s) 342 are configured to heat substantially the entire aerosol generating segment 382 comprising the aerosol generating material 302. In any of the above embodiments, the maximum extent of aerosol generating material 302 away from the or each resistive heating layer 340 is less than a maximum radial dimension of the article 300, for example, the maximum distance aerosol generating material 302 is located away from a resistive layer 340 is less than the diameter of the article 300.

The planar area of material defining the resistive heating layer 340 in contact with the aerosol generating segment 382 is greater than the circumferential surface area of the aerosol generating segment 382.

In any of the above embodiments, the or each resistive heating element 342 extends at least substantially along a longitudinal length of the aerosol generating segment 382. In embodiments, the or each resistive heating element extends at least a majority of a diametric width of the aerosol generating segment 382. In embodiments, the or each resistive heating element extends at least substantially a diametric width of the aerosol generating segment. In embodiments, the or each resistive heating element 342 extend in the aerosol generating segment.

FIG. 8 shows a schematic perspective view of an embodiment of the aerosol generator 304. The aerosol generator 304 substantially surrounds the aerosol generating segment 382. The aerosol generator 304 comprising the resistive heating layer 340. In the embodiment shown in FIG. 8, the resistive heating layer 340 surrounds the aerosol generating segment 382 and in in turn the aerosol generating material 302. The resistive heating layer 340 encircles the aerosol generating segment 382. At least one resistive heater 342 as shown with reference to FIG. 5 is disposed on an inward side such that it faces in an inward direction towards the aerosol generating material 302. The aerosol generator 304 have a substantially cylindrical form. The aerosol generator 304 comprise a tubular form having a circular cross-section.

In embodiments, the resistive heating layer 340 comprises a plurality of resistive heating elements 342. The plurality of resistive heating elements 342 in embodiments are connected in series.

The resistive heating layer 340 is folded such that the at least one electrical contact of the first 360 and the electrical contact of the 365 second type is facing in an outward direction away from the aerosol generating material 302. The at least one electrical contact of the first type 360 and the electrical contact 365 of the second type are disposed at the upstream end of aerosol generating segment 382. The fold extends perpendicular to the longitudinal axis and defines an end of the aerosol generator 304.

Other embodiments are envisaged in which the fold extends parallel to the longitudinal axis. The upstream end opposes the mouth end of the article 300.

Once folded, the resistive heating layer 340 comprises a heating panel 368 comprising the at least one resistive heating element 342 and an electrical contact panel 367 comprising the at least one electrical contact of the first type 360 and the electrical contact of the second type 365. The folded aerosol generating layer 340 is wrapped around the aerosol generating material 302. In the embodiment of FIG. 8, the resistive heating panel 368 and the electrical contact panel 367 are unitary. Other embodiments are envisaged in which the resistive heating panel 368 and the electrical contact panel 367 are distinct elements that are electrically connected.

In embodiments, the resistive heating layer 340 can be folded such that the at least one electrical contact of the first type 360 may be facing in a direction away from the aerosol generating material 302 and the at least one electrical contact of the second type 365 may be facing towards, and/or touching the aerosol generating material 302, or vice versa.

In embodiments, the resistive heating panel 368 and the electrical contact panel 367 extend parallel to each other. The resistive heating panel 368 and the electrical contact panel 367 sandwich a support layer 350 (refer to FIG. 11), that is the resistive heating panel 368 is on a first side of the support layer 350 and the electrical contact panel 367 is on a second side of the support layer 350.

In the embodiment shown in FIG. 8, the electric contact panel 367 circumscribes the aerosol generating segment 382.

In embodiments, the fold defines a first support layer panel of the support layer 350 and a second support layer panel of the support layer 350. In such embodiments, the resistive heating element panel 368 is on the first support layer panel of the support layer 350 and the electrical contact panel 367 is on the second support layer panel of the support layer 350. The first support layer panel and the second support layer panel of the support layer may extend in parallel and may be mounted together, for example, by bonding.

Other embodiments are envisaged in which the electrical contact panel 367 is a first electrical contact panel comprising the electrical contact of the first type 360 and the fold defines a second electrical contact panel comprising the electrical contact of the second type 365.

In embodiments, the electrical contact panel 367 overlaps the resistive heating element panel 368. In embodiments, the article 300 comprises a wrapper circumscribing a portion of the resistive heating layer 340. In an embodiment, the wrapper overwraps at least a portion of the resistive heating element panel 368. In embodiments, at least a portion of the electrical contact panel is free from being circumscribed by the wrapper. In embodiments, an edge of the electrical contact panel 367 abuts an edge of the wrapper.

Other embodiments are envisaged in which the electrical contact panel 367 lies on the same circumferential plane as the wrapper. The first type of electrical contact 360 and the second type of electrical contact 365 may be substantially exposed.

In any of the above embodiments, the wrapper is a paper or card wrapper. The aerosol generator 382 may abut the wrapper. In any of the above embodiments, the wrapper defines an outer layer of the article

In embodiments. the electrical contact of the first type 360 extends to a first edge of the resistive heating layer 340 and the electrical contact of the second type 365 extends to a second edge of the resistive heating layer 340. The first and second edge may extend parallel to each other. The electrical contact of the first type 360 and the electrical contact of the second type 365 may extend adjacent to each other, for example, in the manner shown in FIG. 8.

The aerosol generating layer 340 substantially surrounds the aerosol generating material 302 across its entire length. The resistive heating element 342 of the resistive heating panel 386 is disposed on the inward side and faces in a direction towards the aerosol generating material 302 when in the wrapped configuration. The aerosol generating material can be in direct contact with the resistive heating element 342. In embodiments, the resistive heating element 342 extends at least substantially along an entire longitudinal extent of the aerosol generating segment 382.

In the embodiment of FIG. 8, a wrap may encircle the article 300 and forms part of the article 300. The wrap may comprise a sheet. In embodiments the wrap may include the resistive heating layer 340. The Wrap may act as a fixed sleeve.

In any of the above embodiments discussed, for example, with reference to FIG. 8, the or each resistive heating element 342 is configured to heat substantially the entire aerosol generating segment 382 comprising the aerosol generating material 302. In any of the above embodiments, the maximum extent of aerosol generating material 302 away from the resistive heating layer(s) 340 is less than a maximum radial dimension of the article 300, for example, the maximum distance aerosol generating material 302 is located away from a resistive heating layer 340 is less than the diameter of the article 300.

In any of the above embodiments, for example as discussed with reference to FIG. 8, the or each resistive heating element 342 extends at least substantially along a longitudinal length of the aerosol generating segment 382.

Any of the embodiments described above may be combined in a suitable manner, For example, the embodiments as described with reference to FIGS. 3, 6 and 7 may be combined with the embodiments as described with reference to FIG. 8. The article 300 may comprise a first aerosol generator 304 that is embedded within the aerosol generating material 302 in accordance, for example, with the embodiments shown and discussed with reference to FIGS. 3, 5, 6 and 7 and the article 300 may further comprise a second aerosol generator 304 that surrounds the aerosol generating material 302 in accordance, for example, with the embodiment shown and discussed with reference to FIG. 8.

In embodiments, the article 300 comprises a resistive heating configuration comprising the aerosol generator 304 and the resistive heating layer 340 of any of the above embodiments in any configuration or combination described herein. For example, the aerosol generator 304 as described with reference to FIGS. 3, 6 and 7 may be a discrete element embedded within the aerosol generating segment 382 and the aerosol generator 304 of FIG. 8 may be a second discrete element that surrounds the aerosol generating segment 382, in the manner as described in any of the above embodiments. In embodiments, the resistive heating layers are integral with each other.

FIGS. 9 and 10 show further embodiments of the resistive heating configuration.

FIG. 9 shows an embodiment of the resistive heating configuration in which the resistive heating layer 340 comprises two sections, a first section 340a and a second section 340b. The first section 340a and the second section 340b can be considered as the resistive heating configuration. The first section 340a in use, is embedded within the aerosol generating material 302. The first section 340a comprises a first internal panel 388 and a second internal panel 387. The first internal panel 388 comprises at least one electrical contact of the first type 360. The second internal panel 387 comprises at least one electrical contact of the second type 365. In embodiments, the configuration of electrical contacts is reversed. The electrical contacts, in use, are disposed at the upstream end of the article 300.

In embodiments, the first section 340a extends transversely from the first section 340b.

The first section 340a and the second section 340b are unitary. In embodiments. the first section 340a and the second section 340b are formed from a single sheet of material. In such embodiments, the at least one first type of electrical contact 360 and the second type of electrical contact 365 are formed by the single sheet of material.

An underside of the first internal panel 388 is adjacent to an underside of the second internal panel 387. The first internal panel and second internal panel are separated by a support, such as support 350.

The resistive heating element 342 extends from the first internal panel 388 of the first section 340a over the second section 340b, to the second internal panel 387 of the first section 340a. Other embodiments are envisaged where there are a plurality of resistive heating elements 342, for example, the first internal panel 388 of the first section may comprise a resistive heating element, or the first internal panel 388 may comprise a plurality of heating elements 342. One or a plurality of resistive heating elements may extend across the second section 340b. The second internal panel 387 may comprise one or a plurality of resistive heating element(s) 342. Therefore, in embodiments, there can be considered at least three resistive heating panels, the second internal panel 387, the first internal panel 388 and the section 340b comprising a resistive heating element (corresponding to the third panel).

The second section 340b encircles the aerosol generating segment 382.

The resistive heating layer 340 in this embodiment of FIG. 9 is formed from a single sheet. The sheet comprises a first fold 385 to form the second internal panel 387 of the first section 340a and a second fold to form the second section 340b and the first internal panel of the first section 340a. The sheet is folded along the longitudinal extent of the aerosol generating layer 340 at folds 385 and 386. In embodiments, the fold(s) extends parallel to the longitudinal axis. In embodiments, the fold(s) extends the longitudinal extent of the aerosol generating layer 340.

In embodiments, a resistive heating element 342 extends across one or each of the folds.

The resistive heating element 342 disposed on the second section 340b are in external contact with the aerosol generating segment 382. The resistive heating element(s) 342 of the first section 340a are in internal contact with the aerosol generating segment 382.

The embodiment as shown in FIG. 10 shows a modified embodiment of the aerosol generating layer 340 of FIG. 9. The reference numerals of FIG. 10 correspond to the same features of the corresponding reference numerals of FIG. 9. The alternative embodiments discussed above with reference to FIG. 9 apply to FIG. 10 also.

FIG. 10 differs from FIG. 9 in that the aerosol generating layer 340 comprises a first fold 389 and a second fold 390. In this embodiment, fold 380 forms the first internal panel 388 and the second internal panel 387 of the first section. The second fold 390 forms the second section 340b. The sheet is folded along the longitudinal extent of the aerosol generating layer 340 at folds 389 and 390.

Although the embodiments of FIGS. 9 and 10 show the electrical contacts depending from the top 388 and bottom 387 panels of the first section 340 a, other embodiments are envisaged where the second section 340b is folded in a similar manner to the embodiment discussed above in relation to FIG. 8 such that at least one electrical contact of the first type 360 and an electrical contact of the second type 365 is disposed at an upstream end of the resistive heating later such that they are directed in a direction facing away from the aerosol generating material. In this embodiment, the first internal panel 388 and the second internal panel do not comprise any electrical contacts.

Other embodiments are envisaged wherein the first internal panel 388 or second internal panel 387 comprises at least one electrical contact of the first type or the second type and the second section 340b comprises at least one electrical contact of the alternative type. For example, if the top 388 or bottom 387 panel comprises an electrical contact of the first type then the second section 340b comprises an electrical contact of the second type. If the top 388 or bottom 387 panel comprises an electrical contact of the second type then the second section 340b comprises an electrical contact of the first type.

In an embodiment, the first section 340a comprises a single panel having a single contact of the first type 360 or the second type 365 and the second section 340b has a single contact of the first type 360 or the second type 365.

In an embodiment, the first internal panel 388 and the second internal panel 387 of the first section 340a may comprise a fold that upturns the respective upstream ends to form a single electric contact of the first type 360 or the second type 365. In this embodiment, the first internal panel 388 and second internal panel 387 are electrically connected. In this embodiment, the second panel 340b comprises an electrical contact of the opposite type of the first section 340a.

In embodiments where one of the first internal panel 388 or second internal panel 387 comprises at least one electrical contact, the at least one electrical contact protrudes from the upstream end of the article. In embodiments where the second section 340b comprises at least one electrical contact, the at least one electrical contact protrudes from the upstream end of the article. Other embodiments are envisaged wherein at least one (or all) electrical contact(s) terminates such that it is substantially flush with an upstream end of the aerosol generating segment 382. The at least one (or all) electrical contact(s) may be recessed within the aerosol generating component 382. In embodiments, the aerosol generating material 302 may comprise a void at the upstream end, wherein the at least (or all) one electrical contact(s) extends in the void.

It will be understood that the above design freedom provides flexibility with regards to the design and placement of the device electrical contacts within the aerosol generating device 200.

The or each resistive heating element(s) 342 as described in any of the embodiments with reference to FIGS. 9 and 10 are configured to heat substantially the entire aerosol generating segment 382 comprising the aerosol generating material 302. In any of the embodiments, the maximum extent of aerosol generating material 302 away from the resistive heating layer(s) 340 is less than a maximum radial dimension of the article 300, for example, the maximum distance aerosol generating material 302 is located away from a resistive heating layer 340 is less than the diameter of the article 300.

In embodiments in which the (or part of the) aerosol generating layer 340 is planar, the planar area of material defining the resistive heating layer 340 in contact with the aerosol generating segment 382 is greater than the circumferential surface area of the aerosol generating segment 382.

In any of the above embodiments, the (or each) resistive heating element(s) 342 extends at least substantially along a longitudinal length of the aerosol generating segment 382. In embodiments, the (or each) resistive heating element(s) extend at least a majority of a diametric width of the aerosol generating segment 382. In embodiments, the (or each) resistive heating element 342 extends at least substantially a diametric width of the aerosol generating segment. In embodiments, the (or each) resistive heating element(s) 342 extend in the aerosol generating segment 382.

In any of the above embodiments, the resistive heating layer 340 has a thickness of less than 10 microns. Other embodiments are envisaged in which the thickness is between 4 and 8 microns, or about 6 microns. By providing the resistive heating layer in a wrapped configuration and/or in an embedded configuration as described above it is possible to minimise the thickness of the resistive heating layer

In any of the above embodiments, a wrap may encircle the article 300 and forms part of the article 300. The wrap may comprise a sheet. The wrap acts as a fixed sleeve. The or each aerosol generator 304 of the above embodiments may protrude from the wrap at the upstream end. The heater electrical contacts 322 are exposed at the upstream end.

In any of the above embodiments, the or each resistive heating element(s) as described in ay of the foregoing is configured to heat substantially the entire aerosol generating segment 382 comprising the aerosol generating material 302. In any of the above embodiments, the maximum extent of aerosol generating material 302 away from the resistive heating layer(s) 340 is less than a maximum radial dimension of the article 300, for example, the maximum distance aerosol generating material 302 is located away from a resistive heating element 342 is less than the diameter of the article 300.

The area of material defining the resistive heating layer 340 in contact with the aerosol generating segment 382 is greater than the circumferential surface area of the aerosol generating segment 382.

In any of the above embodiments, the (or each) resistive heating element(s) 342 extends at least substantially along a longitudinal length of the aerosol generating segment 382. In embodiments, the (or each) resistive heating element(s) extend at least a majority of a diametric width of the aerosol generating segment 382. In embodiments, the (or each) resistive heating element extends at least substantially a diametric width of the aerosol generating segment. In embodiments, the (or each) resistive heating element(s) 342 extend in the aerosol generating segment.

In any of the above embodiments, the resistive heating layer 340 defines a heating surface area, wherein the heating surface area is at least 100 mm². In embodiments, the heating surface area is at least 200 mm², or at least 300 mm².

An example of the aerosol generator 304 is schematically shown in cross section in FIG. 11. The aerosol generator 304 is an implementation of the aerosol generator 304 in any of the above embodiments. In embodiments, the surface area of the resistive heating layer(s) 340 in contact with the aerosol generating segment 382 is greater than the circumferential surface area of the aerosol generating segment 382.

The aerosol generating segment 382 comprises the aerosol generating material 302 described in the foregoing. The aerosol generator 304 comprises a resistive heating layer 340 according to any of the above embodiments. The resistive heating layer 340, in embodiments, is formed as an electrically conductive layer. The aerosol generating segment 382 is on the resistive heating layer 340. The aerosol generating segment 382 is in direct contact with the resistive heating layer 340. In embodiments, the aerosol generating segment 382 is in indirect contact with the resistive heating layer 340. The resistive heating layer 340 may in embodiments comprise a coating. As described in detail above with reference to FIG. 5, the resistive heating layer 340 comprises a resistive heating element 342. In embodiments, the resistive heating layer comprises a plurality of resistive heating elements 342. The or each resistive heating element 342 forms at least a portion of an electrically conductive path between a pair of the electrical contacts 322. The or each resistive heating element 342 provides the electrically conductive path for resistive heating of at least of portion of the aerosol generating material 302 to generate an aerosol.

The resistive heating layer 340 is formed as an electrically conductive layer. This layer in embodiments takes the form of at least one of a metal layer, such as an aluminium layer, or a non-metallic material, such as graphene. The resistive heating layer 340 is in the form of a foil, for example an aluminium foil.

The aerosol generator 304 in any of the above embodiments comprises a support 350. The support 350 in embodiments comprise a paper or card material. The support 350 provides structural support for the aerosol generator 304. The resistive heating layer 340 is on the support 350. The support 350 is configured as a support layer. As shown in FIG. 11, in the aerosol generator 304, the resistive heating layer 340 is sandwiched between the support 350 and the aerosol generating segment 382.

The support 350 is electrically insulative. The resistive heating layer 340 and the support layer 350 define a substrate 352. The substrate 352 supports the aerosol generating segment 382.

The article 300 may comprise a laminate 354 comprising the resistive heating layer 340 and the support layer 350.

One or more of the aerosol generating segment 382, resistive heating layer 340 and the support layer 350 may comprise a further layer. For example, the support layer 350 may comprise a backing layer or an intermediate layer. The support layer 350 in embodiments is omitted.

FIG. 12 is a flow chart showing part of a method of forming an aerosol generator 304 or an algorithm, indicated generally by the reference numeral 400, in accordance with an example embodiment.

The method or algorithm 400 starts at operation 402, where a resistive heating layer is formed into one or more heating elements (e.g. a plurality of heating elements), wherein each resistive heating element extends from an electrical contact of a first type to an electrical contact of a second type. In use, the or each heating element may be used to provide an electrically conductive path for resistive heating of a portion of an aerosol generating material to generate an aerosol. The formation of the or each resistive heating element may occur prior to or post application of the resistive heating layer on a support, where a support is present. The resistive heating layer may be adhered to the support, or mounted or formed on the support in a different configuration.

At operation 404, the formed resistive heating layer is placed in contact with the aerosol generating segment, wherein said aerosol generating segment incorporates aerosol generating material. Algorithm 400 may be used to produce the aerosol generator 304 described in any of the above embodiments.

FIG. 12 shows the resistive heating layer 340 being formed in accordance with an example embodiment. The resistive heating layer 340 is in the process of being cut using a laser cutter 408. The cutting of the resistive heating layer 340 can be used to form the paths of the heating elements described herein. The use of the laser cutter 408 (or some other cutting process) is not the only method by which the resistive heating layer 340 described herein may be generated. Some example methods are described below.

FIG. 14 is a flow chart showing part of a method of forming an aerosol generator 304 or an algorithm, indicated generally by the reference numeral 410. The method or algorithm 410 starts at operation 412, where the resistive heating layer is provided. At operation 414, one or more of the resistive heating elements are formed in the resistive heating layer by chemically etching the resistive heating layer. The operations 412 and 414 are an example implementation of the operation 402 of the method 400 described above. The aerosol generating material is then disposed on the resistive heating layer in operation 416. The operation 416 is therefore an example implementation of the operation 404 described above.

FIG. 15 is a flow chart showing part of a method of forming an aerosol generator 304 or an algorithm, indicated generally by the reference numeral 418. The method or algorithm 418 starts at operation 420, where one or more heating elements are formed, at least in part, by printing a resistive heating layer. The operation 420 is therefore an example implementation of the operation 402 of the algorithm 400 described above. The aerosol generating material is then disposed on the resistive heating layer in operation 422. The operation 422 is therefore an example implementation of the operation 404 described above.

The cutting, etching and printing methods described above are provided by way of example; other additional or alternative methods are also possible. For example, a so-called “hot foiling” approach could be used in which a heating element is made out of a resistive heating layer, and then assembled/bonded onto a support. Yet other techniques could be used, such as die cutting. Moreover, two or more technologies could be combined (e.g. electrical conductivity could be added to connection traces by adding more conductive material, such as additional foil, printed material, etc.). The skilled person will be aware of many further technologies, or combinations of technologies, that could be used in implementations of the principles described herein.

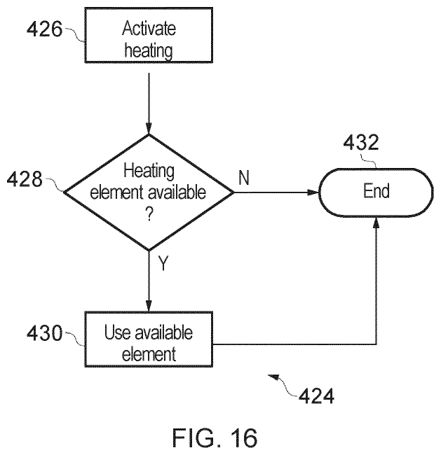

FIG. 16 is a flow chart showing method of operation or an algorithm, indicated generally by the reference numeral 424, in accordance with an example embodiment. The method or algorithm 424 may, for example, be implemented using any of the aerosol generators described herein. The method or algorithm 424 is initiated when an instruction to activate heating is received in an instance of operation 426. In response to the instruction to activate heating, a determination is made (in operation 428) regarding whether a heating element is available. As discussed above, a plurality of heating elements may be provided. The operation 428 may involve determination which of the heating elements have been used and/or the corresponding available aerosol generating material used up.

If a heating element is available, the algorithm moves to operation 430, where an available heating element is used. As discussed above, heating elements may be individually controllable, for example by providing electrical power to individual heating elements. Once the operation 430 is complete, the algorithm terminates at operation 432. If, at operation 428, a determination is made that no heating elements are available, for example because all heating elements have been used, then the algorithm terminates at operation 432. This may mean that a consumable part being used to implement the algorithm 424 needs to be replaced.

As described herein the article forms part of a system with an aerosol provision device. In embodiments, an aerosol provision device comprises the article.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An article for an aerosol provision device comprising:
an aerosol generating segment comprising aerosol generating material;
a resistive heating configuration including a resistive heating layer comprising a resistive heating element configured to heat at least a portion of the aerosol generating material to generate an aerosol;
a first type of electrical contact; and
a second type of electrical contact;
wherein the resistive heating element is at least a portion of an electrically conductive path between the first type of electrical contact and the second type of electrical contact; and
wherein the resistive heating configuration is in an external contact with the aerosol generating segment and in an internal contact with the aerosol generating segment.

2. The article of claim 1, wherein the resistive heating layer is in external contact with the aerosol generating segment and in internal contact with the aerosol generating segment.

3. The article of claim 1, or wherein an external portion of the resistive heating element is in external contact with the aerosol generating segment and an internal portion of the resistive heating element is in internal contact with the aerosol generating segment.

4. The article of claim 1, comprising an internal portion of the resistive heating configuration forming the internal contact with the aerosol generating segment and an external portion of the resistive heating configuration forming the external contact with the aerosol generating segment.

5. The article of claim 4, wherein the internal portion of the resistive heating configuration extends in the aerosol generating segment and the external portion of the resistive heating configuration at least partially circumscribes the aerosol generating segment.

6. The article of claim 4, wherein each of the internal portion and the external portion of the resistive heating configuration comprise the resistive heating layer.

7. The article of claim 4, wherein the internal portion and the external portion of the resistive heating configuration are unitary.

8. The article of claim 4, wherein the internal portion of the resistive heating configuration extends transversely from the external portion.

9. The article of claim 4, comprising a fold defining the internal portion and the external portion of the resistive heating configuration.

10. The article of claim 9, wherein the fold is a first fold and comprising a second fold, wherein the second fold defines a section of the internal portion of the resistive heating configuration.

11. The article of claim 10, wherein the second fold is disposed in the aerosol generating segment.

12. The article of claim 10, wherein the resistive heating configuration is folded in an opposing direction about the second fold than about the first fold.

13. The article of claim 4, wherein the resistive heating element is a first resistive heating element defined by the internal portion of the resistive heating configuration and the resistive heating configuration comprises a second resistive heating element defined by the external portion of the resistive heating configuration.

14. An aerosol provision system comprising an article of claim 1, , and an aerosol provision device configured to receive the article.

15. A method of forming an article for an aerosol provision device, the method comprising:
forming a resistive heating configuration comprising a resistive heating layer comprising a resistive heating element configured to heat at least a portion of aerosol generating material to generate an aerosol, a first type of electrical contact and a second type of electrical contact, wherein the resistive heating element is at least a portion of an electrically conductive path between the first type of electrical contact and the second type of electrical contact;
disposing an internal portion of the resistive heating configuration in contact with an aerosol generating segment comprising aerosol generating material; and
disposing an external portion of the resistive heating configuration in contact with the aerosol generating segment.
